(19) United States
(12) Patent Application Publication
(10) Pub. No.: US 2003/0212753 A1
(43) Pub. Date: Nov. 13, 2003

(54) Method and system of data synchronization using HTTP

(76) Inventor: Chien-Chou Lai, Taoyuan City (TW)

Correspondence Address: MARTINE & PENILLA, LLP, 710 LAKEWAY DRIVE, SUITE 170, SUNNYVALE, CA, 94085, US

(21) Appl. No.: 10/202,365

(22) Filed: Jul. 23, 2002

(30) Foreign Application Priority Data
May 9, 2002 (TW) 91109865

(51) Int. Cl. G06F 15/16

(52) U.S. Cl. 709/217

(57) ABSTRACT

A method of data synchronization using hypertext transfer protocol (HTTP), in which a first electronic device transforms an HTTP message into data that can be transmitted via an underlying transmission protocol, and transmits the data via the underlying transmission protocol to a second electronic device. The second electronic device receives the data transmitted via the underlying transmission protocol, returns the data to the HTTP message; and provides various network services according to the content of the HTTP message.

### BACKGROUND OF THE INVENTION

1. Field of the Invention

The invention relates to a method and system of data synchronization and, more particularly, to a method and system of data synchronization using hypertext transfer protocol (HTTP).

2. Description of the Related Art

Along with the development of computer technology, various kinds of mobile electronic devices, such as personal digital assistants (PDAs) and Pocket PCs, have been developed. Mobile electronic devices are widely used due to their portability.

It has been an important issue to perform data synchronization between a mobile electronic device and a desktop computer or a data sync server. Conventionally, there exists no standardized data synchronization method. Each company has its own way to perform data synchronization. After the connection between a mobile electronic device and a computer or server has been established, the data sync programs on both sides begin to perform data transmission and comparison. During data transmission, the data sync programs transmit data in different ways according to different underlying data transmission protocols.

The above-mentioned technique has disadvantages. Firstly, because there is no unified data synchronization standard, the data sync programs has to handle the underlying data transmission protocol while performing data synchronization procedures. This increases the cost of program development.

Furthermore, a mobile electronic device and a data sync server transmit data in a peer-to-peer manner. Thus, it is hard for a computer or a data sync server to perform data synchronization with multiple mobile electronic devices at the same time. A programmer must design a sync program that has the capability of handling multiple peer-to-peer data transmission.

Moreover, before performing data synchronization, a user has to setup peer-to-peer transmission settings on both sides for data synchronization. It is not possible for the user to initiate the data synchronization procedures solely on the mobile electronic device side.

### SUMMARY OF THE INVENTION

In view of the above, an objective of the invention is to provide a method and system of data synchronization, which can reduce the cost and difficulty of data sync program development.

Another objective of the invention is to provide a method and system of data synchronization, which allows a computer or a data sync server to perform data synchronization with multiple mobile electronic devices at the same time.

Still another objective of the invention is to provide a method and system of data synchronization, which allows a user to initiate a data synchronization procedure solely on the mobile electronic device side.

To achieve the above-mentioned objectives, the invention utilizes standard hypertext transfer protocol (HTTP) for data synchronization. According to the invention, a first electronic device transforms an HTTP message into data that can be transmitted via an underlying transmission protocol, and transmits the transformed data via the underlying transmission protocol to a second electronic device. The second electronic device receives the transformed data transmitted via the underlying transmission protocol, returns the transformed data to the HTTP message; and provides various network services according to the content of the HTTP message.

The first electronic device may embed to-be-synced data in the HTTP message. The HTTP message may include extensible markup language (XML) data or multi-purpose Internet mail extensions (MINE) data. Moreover, the second electronic device may transmit an HTTP response corresponding to the HTTP message to the first electronic device.

The invention also discloses a system of data synchronization using HTTP, which includes an HTTP proxy and an HTTP daemon. The HTTP proxy is provided in a first electronic device for transforming an HTTP message into data that can be transmitted via an underlying transmission protocol, and transmitting the transformed data to the HTTP daemon via the underlying transmission protocol. The HTTP daemon is provided in a second electronic device for receiving the transformed data from the underlying transmission protocol, returning the transformed data to the HTTP message, and distributing the HTTP message according to the content of the HTTP message.

The underlying transmission protocol may be the RS-232 transmission protocol. The first electronic device may be a mobile electronic device, and the second electronic device may be a data sync server.

According to the invention, since electronic devices on both sides use HTTP for data synchronization, the user of the first electronic device does not have to establish a peer-to-peer connection between the two electronic devices. Therefore, the method and system according to the invention is more convenient and flexible for the user when performing data synchronization.

Moreover, the data sync program can transmit the to-be-synced data using standard HTTP directly, and does not have to handle the underlying transmission protocol. The underlying transmission protocol is handled by the HTTP proxy and the HTTP daemon on both sides. Therefore, the cost and difficulty of program development is significantly reduced.

Furthermore, the second electronic device can provide data synchronization services to multiple first electronic devices at the same time, thus increases the efficiency and flexibility during data synchronization of multiple electronic devices.

### BRIEF DESCRIPTION OF THE DRAWINGS

FIG. 1 is a block diagram showing an architecture realizing the method of data synchronization according to an embodiment of the invention.

FIG. 2 is a schematic diagram showing data transform according to the embodiment of the invention.

FIG. 3 is a block diagram illustrating the architecture of HTTP proxy according to the embodiment of the invention.

FIG. 4 is a block diagram illustrating the architecture of HTTP daemon according to the embodiment of the invention.

FIG. 5 is a flowchart showing the operation procedure of the first electronic device according to the embodiment of the invention.

FIG. 6 is a flowchart showing the operation procedure of the second electronic device according to the embodiment of the invention.

FIG. 7 is a block diagram showing the architecture of a data synchronization system according to another embodiment of the invention.

### DETAILED DESCRIPTION OF THE PREFERRED EMBODIMENTS

The data synchronization method and system according to a preferred embodiment of the invention will be described below with reference to accompanying drawings, wherein the same elements is designated with the same reference numbers.

Referring to FIG. 1, the method of data synchronization according to a preferred embodiment of the invention is implemented in a first electronic device 1 and a second electronic device 2. The first electronic device 1 is a mobile electronic device, which includes a data sync program 11 and an HTTP proxy 12. The second electronic device is a data sync server, which includes an HTTP daemon 21 and various network services 22. The first electronic device 1 and the second electronic device 2 each includes a microprocessor and an electronic device-accessible storage medium. The elements of the electronic devices record or transmit information using electronic signals having physical quantities.

It should be noted that the hardware architecture might be different according to actual situations or requirements. For example, the first electronic device 1 may use a reduced instruction set computing (RISC) processor as its central processing unit (CPU) based on heat-dissipation or volume considerations. The second electronic device 2 may use a CPU chipset including an arithmetic logic unit (ALU) for mathematical and logical calculations, registers for temporary data and instruction storage, and a control unit for controlling various operations of the second electronic device 2. Moreover, the second electronic device 2 may use a hard disk or a dynamic random access memory (DRAM) as the storage medium.

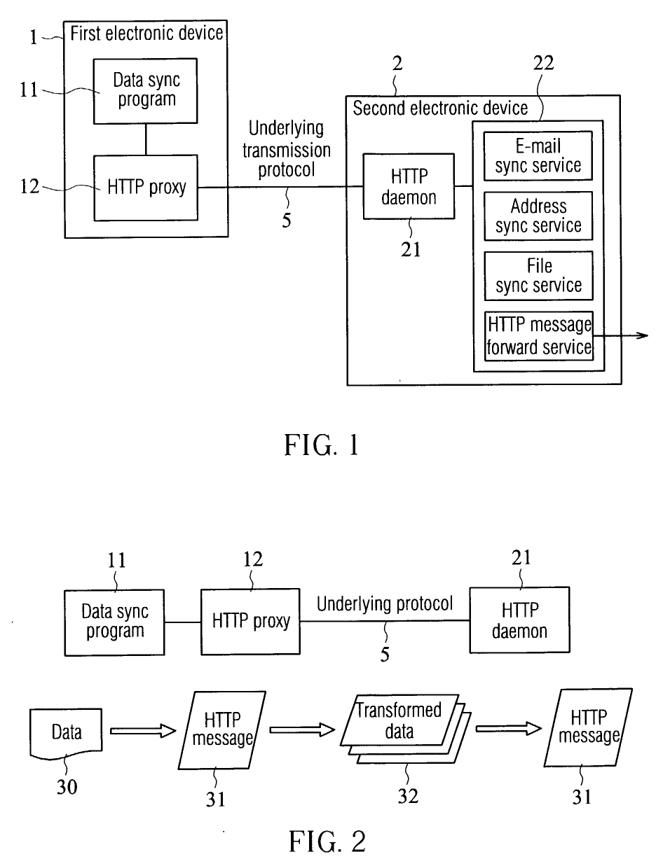

Referring to FIG. 2, in the present embodiment, the data sync program 11 embeds the to-be-synced data 30 in an HTTP message 31. For instance, the data sync program 11 can use the POST method of the standard HTTP to pack the to-be-synced data 30 using extensible markup language (XML) or multi-purpose Internet mail extensions (MIME), and generate an HTTP header to create the HTTP message 31. Then, the HTTP proxy 12 transforms the HTTP message 31 into transformed data 32 that can be transmitted according to the underlying transmission protocol. After being transmitted to the HTTP daemon 21 of the second electronic device 2 via the under transmission protocol, the transformed data 32 are returned to the original HTTP message 31. The HTTP message 31 is then passed to its corresponding network service 22 according to its content. The corresponding network service may be data sync service, e-mail service, or HTTP proxy service that transmit an HTTP message to another remote server on the Internet.

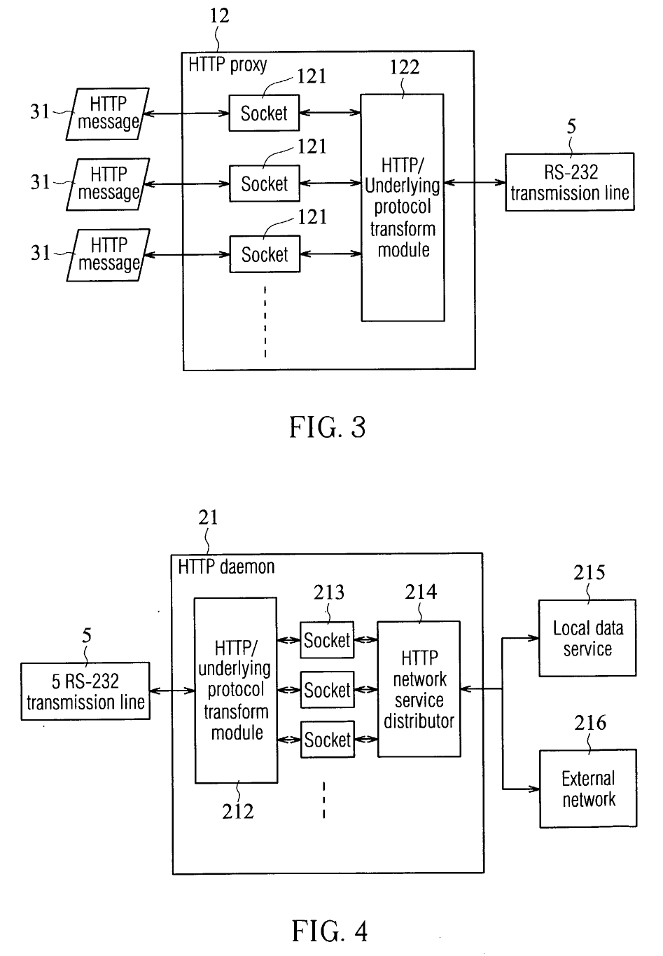

Referring to FIG. 3, for example, if the underlying transmission protocol is the well-known RS-232 protocol, then after receiving the HTTP message 31 to be synced from the data sync program 11, proxy 12 establishes a network connection for the data sync program 11. Then, the data sync program 11 transmits and receives data using the socket 121 of this network connection. The HTTP proxy 12 transforms the HTTP message 32 into a format that can be transmitted via RS-232, and transmits the same to the second electronic device 2.

Referring to FIG. 4, the second electronic device 2 continuously listens whether a connection request from the first electronic device 1 is received. When receiving a connection request from the first electronic device 1, the second electronic device 2 receives data according to the underlying transmission protocol (the RS-232 protocol in the present example), and returns the received data to the HTTP message 31. The HTTP network service distributor 214 determines the corresponding service of the HTTP message 31 according to its content, and passes it to the corresponding network service, for example, a local data service 215 such as an e-mail sync service and an address book sync service, or connecting an external network 216.

If the HTTP message 31 from the first electronic device 1 requests for an HTTP transmission service to a remote server, the second electronic device 2 will try to establish a connection with the remote server according to the object URL in the HTTP message 31. At this situation, the second electronic device 2 acts as an intermediate node, and is transparent to the data sync program 11 of the first electronic device 1. The data sync program 11 of the first electronic device 1 works as if it is in a unified connection environment, regardless whether the underlying transmission protocol is the RS-232, the infrared ray, or other data transmission protocol.

Moreover, in the aforementioned example, each data transmitted using RS-232 includes a socket number for network connection. RS-232 is a peer-to-peer transmission protocol, and an HTTP message is transmitted in a multi-peer, asynchronous way. Therefore, to transmit an HTTP message correctly via RS-232, each data should include a socket number to indicate origin and destination of each data.

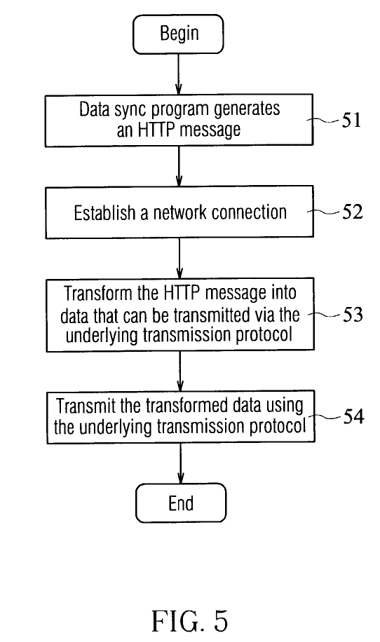

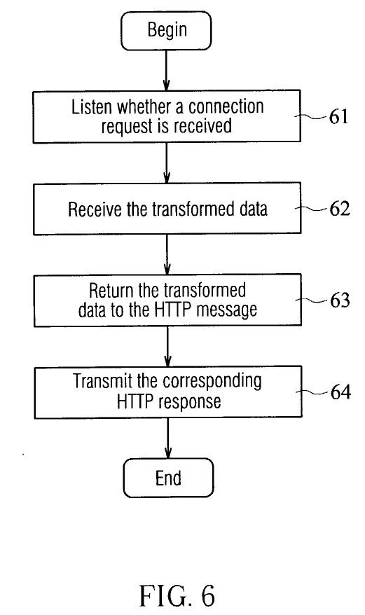

The procedure of the method of data synchronization according to the preferred embodiment of the invention will be described below with reference to FIGS. 5 and 6. FIG. 5 illustrates the operations of the first electronic device 1, and FIG. 6 illustrates the operations of the second electronic device 2.

Referring to FIG. 5, during data synchronization, the data sync program 11 of the first electronic device 1 generates an HTTP message (step 51). The HTTP proxy 12 establishes a network connection for the data sync program 11 after receiving this HTTP message (step 52), so that the data sync program 11 can transmit and receive data using the socket 121 of this network connection. Then, the HTTP proxy 12 transforms the HTTP message into data that can be transmitted via the underlying transmission protocol (step 53), and transmits the transformed data to the second electronic device via the underlying transmission protocol (step 54).

Referring to FIG. 6, the second electronic device 2 continuously listens whether a connection request from the first electronic device 1 is received (step 61). When receiving the connection request from the first electronic device 1, the second electronic device 2 receives data according to the underlying transmission protocol (step 62). The HTTP daemon 21 returns the received data to the HTTP message (step 63), determines the corresponding service of the HTTP message according to its content, and passes it to the corresponding network service. The corresponding network service returns the corresponding HTTP response, and the HTTP daemon transmits this HTTP response to the first electronic device via the underlying transmission protocol (step 64).

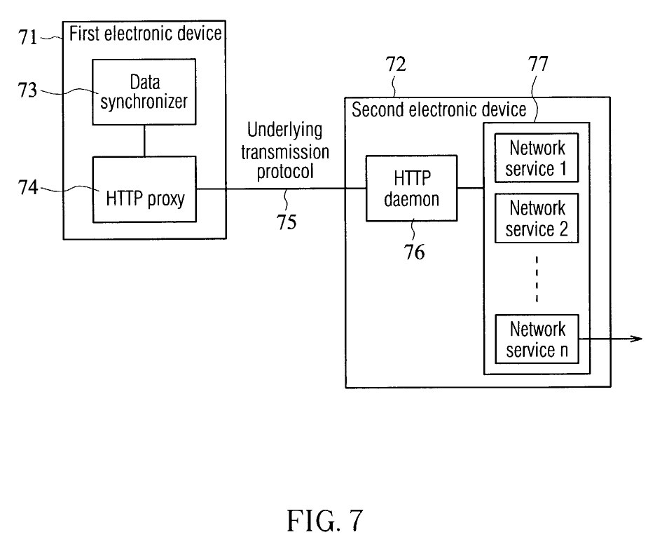

FIG. 7 illustrates the data sync system according to another embodiment of the invention, which includes a data synchronizer 73, an HTTP proxy 74, an HTTP daemon 76 and a plurality of network service 77. The data synchronizer 73 is provided in a first electronic device 71 for embedding to-be-synced data in an HTTP message. The HTTP proxy 74 is also provided in the first electronic device 71 for transforming the HTTP message into data that can be transmitted via an underlying transmission protocol 75, and transmits the transformed data according to the underlying transmission protocol 75. The HTTP service 76 is provided in a second electronic device 2 for receiving the transformed data and returning the data to the HTTP message. The HTTP service 76 also passes the HTTP message to a corresponding network service 77 according to its content. The network services 77 are also provided in the second electronic device 72 for receiving and responding the HTTP message sent from the HTTP service 76.

When performing data synchronization, since electronic devices on both sides use HTTP to communicate, the user of the first electronic device does not have to establish a peer-to-peer connection between the two electronic devices. Therefore, the method and system according to the invention is more convenient and flexible for the user when performing data synchronization.

Moreover, the data sync program can transmit the to-be-synced data using standard HTTP directly, and does not have to handle the underlying transmission protocol. The underlying transmission protocol is handled by the HTTP proxy and the HTTP daemon on both sides. Therefore, the cost and difficulty of program development is significantly reduced. Furthermore, the second electronic device can provide data synchronization services to multiple first electronic devices at the same time, thus increases the efficiency and flexibility during data synchronization of multiple electronic devices.

It should be noted that persons having ordinary skill in the art could make various variations or alternations to the embodiments described above. For example, except for RS-232, the underlying transmission protocol could be the infrared transmission protocol or the Bluetooth transmission protocol. The electronic devices can also exchange data via general packet radio service (GPRS). Therefore, the scope of the appended claims should be accorded the broadest interpretation so as to encompass all such modifications.

What is claimed is:

1. A method of data synchronization using hypertext transfer protocol (HTTP), comprising:
at a first electronic device,
transforming an HTTP message into data that can be transmitted via an underlying transmission protocol; and
transmitting the data via the underlying transmission protocol,
at a second electronic device,
receiving the data transmitted via the underlying transmission protocol;
returning the data to the HTTP message; and
passing the HTTP message to its corresponding network service according to its content.

2. The method according to claim 1, further comprising:
embedding to-be-synced data in the HTTP message at the first electronic device.

3. The method according to claim 1, wherein the HTTP message comprises extensible markup language (XML) data or multi-purpose internet mail extensions (MIME) data.

4. The method according to claim 1, further comprising:
transmitting an HTTP response corresponding to the HTTP message from the second electronic device to the first electronic device.

5. The method according to claim 1, further comprising:
sending a connection request from the first electronic device to the second electronic device.

6. The method according to claim 1, further comprising:
listening, at the second electronic device, whether the connection request is received.

7. The method according to claim 1, wherein the underlying transmission protocol is RS-232 transmission protocol.

8. The method according to claim 1, wherein the first electronic device is a mobile electronic device.

9. The method according to claim 1, wherein the second electronic device is a data sync server.

10. A computer-readable storage medium having instructions recorded thereon for an electronic device to execute the method of data synchronization recited in claim 1.

11. A mobile electronic device that is capable of performing data synchronization with a data sync server, the data sync server including an HTTP daemon and a plurality of network services, the HTTP daemon receiving transformed data from an underlying transmission protocol, returning the transformed data to an HTTP message, and distributing the HTTP message to at least one of the network services according to the content of the HTTP message, the network services receiving and serving the HTTP message sent from the HTTP daemon,
the mobile electronic device comprising:
a data synchronizer for embedding to-be-synced data in the HTTP message; and
an HTTP proxy for transforming the HTTP message into the transformed data that can be transmitted via the underlying transmission protocol, and transmitting the transformed data to the HTTP daemon of the data sync server via the underlying transmission protocol.

12. The mobile electronic device according to claim 11, wherein the HTTP message comprises XML data or MIME data.

13. The mobile electronic device according to claim 11, wherein the HTTP daemon further receives an HTTP response sent from the network service corresponding to the HTTP message, and transmits the HTTP response to the mobile electronic device.

14. The mobile electronic device according to claim 11, wherein the underlying transmission protocol is RS-232 transmission protocol.

15. A data sync server that is capable of performing data synchronization with a mobile electronic device, the mobile electronic device including a data synchronizer and an HTTP proxy, the data synchronizer embedding to-be-synced data in an HTTP message, the HTTP proxy transforming the HTTP message into transformed data that can be transmitted via an underlying transmission protocol, and transmitting the transformed data via the underlying transmission protocol,
the data sync server comprising:
an HTTP daemon for receiving the transformed data from the underlying transmission protocol, returning the transformed data to the HTTP message, and distributing the HTTP message according to the content of the HTTP message; and
a plurality of network services, wherein at lease on of the network services receives and serves the HTTP message sent from the HTTP daemon.

16. The data sync server according to claim 15, wherein the corresponding network service further transmits an HTTP response of the HTTP message to the mobile electronic device.

17. The data sync server according to claim 15, wherein the HTTP message comprises XML data or MIME data.

18. The data sync server according to claim 15, wherein the HTTP proxy further receives an HTTP response sent from the network service corresponding to the HTTP message.

19. The data sync server according to claim 15, wherein the underlying transmission protocol is RS-232 transmission protocol.
